(19) United States
(12) Patent Application Publication
(10) Pub. No.: US 2007/0113210 A1
(43) Pub. Date: May 17, 2007

(54) Method and apparatus for supporting verification, and computer product

(75) Inventors: Yutaka Mizuno, Kawasaki (JP); Tomoharu Awaya, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/362,923

(22) Filed: Feb. 28, 2006

(30) Foreign Application Priority Data
Nov. 16, 2005 (JP) 2005-331725

(51) Int. Cl. G06F 17/50

(52) U.S. Cl. 716/5; 703/16

(57) ABSTRACT

In gates, a gate length is same as that of an isolated Poly on a layout, however, is different from that of the isolated Poly on an actual silicon wafer. When the distance between the gates that is spacing between the gate becomes larger to some degree, the proximity effect is lost and the proximity Poly becomes same as the isolated Poly. In this way, because the correlation with another macro-cell arranged adjacent differs when the distance between the gates differs, the correlation coefficient varies. Therefore, correlation is grouped according to the distance between the gates.

### CROSS-REFERENCE TO RELATED APPLICATIONS

This application is based upon and claims the benefit of priority from the prior Japanese Patent Application No. 2005-331725, filed on Nov. 16, 2005, the entire contents of which are incorporated herein by reference.

### BACKGROUND OF THE INVENTION

1. Field of the Invention

The present invention relates to a technology for supporting timing verification of a semiconductor circuit.

2. Description of the Related Art

Conventionally, to execute timing verification in static timing analysis (STA), it is necessary to set a mutual correlation coefficient of delay for each individual macro-cell that constitutes a circuit system. The correlation coefficient is determined when two macro-cells are designated.

For example, in a technique disclosed in Japanese Patent Application Laid-Open Publication No. 2002-279012, in calculating a delay distribution of an integrated circuit, to consider the correlation between wires or elements in performance, the delay distribution is calculated by providing correlation information set in advance. The maximum value/the minimum value of each gate/delay are set first and the timing verification is executed using the maximum value/the minimum value.

However, in a recent process that has advanced in finer fabrication, variation of the delay within a chip, which is on chip variation (OCV), has become large. This makes the timing verification difficult to be satisfactorily executed with the maximum value/minimum value.

In the conventional technique, correlation information previously prepared is used. The correlation is determined uniformly without considering the characteristics such as the layout shape and the internal configurations of two macro-cells arranged adjacently to each other. Therefore, the timing verification can not be executed accurately.

An approach that executes the timing verification based on statistical variation of the delays within a chip has been also presented. However, it is required to set the mutual correlation for each macro-cell constituting the circuit within the chip.

### SUMMARY OF THE INVENTION

It is an object of the present invention to at least solve the above problems in the conventional technology.

A verification supporting apparatus according to one aspect of the present invention includes a storage unit configured to store data on at least one macro-cell; an acquiring unit configured to acquire data on a macro-cell from the storage unit; an analyzing unit configured to analyze acquired data; and a setting unit configured to set information relating to a correlation coefficient of the macro-cell with respect to an adjacent macro-cell that is arranged adjacent to the macro-cell, based on a result of analysis by the analyzing unit.

A verification supporting method according to another aspect of the present invention includes storing data on at least one macro-cell; acquiring data on a macro-cell from among stored data; analyzing acquired data; and setting information relating to a correlation coefficient of the macro-cell with respect to an adjacent macro-cell that is arranged adjacent to the macro-cell, based on a result of analysis at the analyzing.

A computer-readable recording medium according to still another aspect of the present invention stores a computer program for realizing a verification supporting method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for illustrating correlation of delays;

FIG. 2 is a schematic of a configuration of a verification supporting apparatus according to the embodiment of the present invention;

FIG. 3 is a block diagram of the verification supporting apparatus;

FIG. 4 is a flowchart of a verification supporting process performed by the verification supporting apparatus;

FIG. 5 is a schematic for illustrating layout shapes of transistors according to a first example;

FIG. 6 is a schematic for illustrating layout shapes of transistors according to a second example;

FIG. 7 is a schematic for illustrating layout shapes of transistors according to a third example;

FIG. 8 is a schematic for illustrating layout shapes of inverters according to a fifth example;

FIG. 9 is a schematic for illustrating layout shapes of circuits according to eighth example;

FIG. 10 is a schematic of transistors according to a tenth example;

FIG. 11 is a schematic of transistors according to an eleventh example;

FIG. 12 is a schematic for illustrating layout shapes of transistors according to a twelfth example;

FIG. 13 is a schematic for illustrating layout shapes of transistors according to a fourteenth example; and

FIG. 14 is a schematic of macro-cells according to a fifteenth example.

### DETAILED DESCRIPTION OF THE PREFERRED EMBODIMENTS

Exemplary embodiments according to the present invention will be described in detail with reference to the accompanying drawings. A correlation coefficient is a value indicating a degree of correlation between two variables, and the correlation efficient relating to delay is a value indicating the degree of correlation between two circuit elements, using the delays of two circuits.

The correlation coefficient relating to delay (hereinafter, “delay correlation coefficient”) takes a value of −1≦R≦1, where the delay correlation coefficient is R. The closer the delay correlation coefficient R is to zero, the weaker causality between two circuits is, and the further away the delay correlation coefficient is from zero, the stronger the causality is.

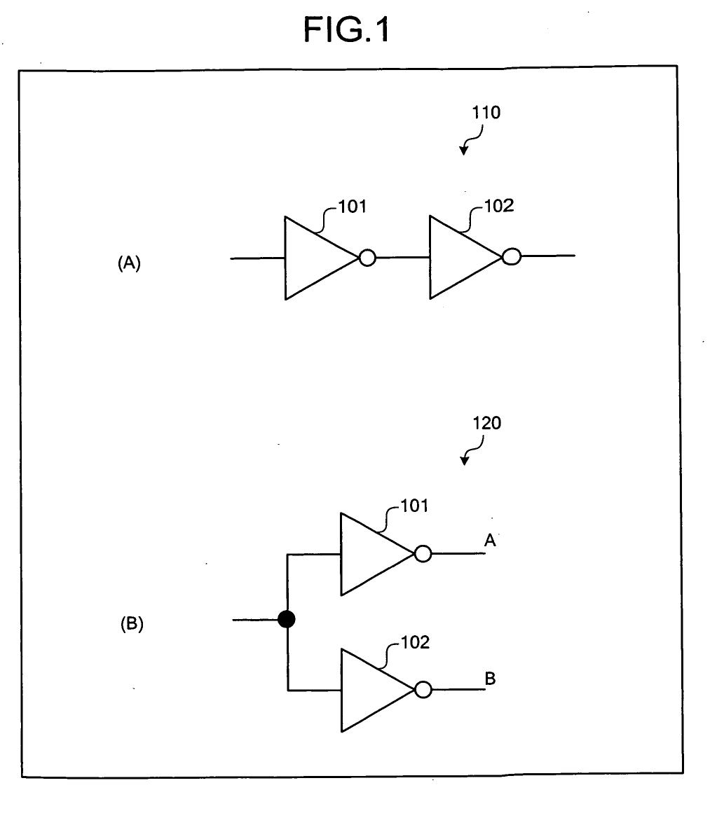

FIG. 1 is a schematic for illustrating the correlation relating to delay. An average value of delay of an inverter 101 and an average value of delay of an inverter 102 are represented as t1 and t2 respectively, and standard deviations of the delay of the inverter 101 and the delay of the inverter 102 are represented as σ1 and σ2 respectively.

When the inverters 101 and 102 are connected with each other in series, the average value “ta” of the delays and the standard deviation σa of the delays of a circuit 110 in series are expressed as:
ta=t1+t2 (1)
σa=σ1²+σ2²+2×σ1×σ2×R (2)

On the other hand, when the inverters 101 and 102 are connected with each other in parallel, the average value “tb” of delay and the standard deviation σb of the delay representing the difference in the delay between output terminals of the inverter 101 and the inverter 102 in a circuit 120 in parallel are expressed:
tb=t1−t2 (3)
σb=σ1²+σ2²−2×σ1×σ2×R (4)

Various methods of calculating the delay correlation coefficient R have been presented and an example of the methods can be expressed in Equation 5 below. In Equation 5, K is a constant and d is the distance between the inverters 101 and 102.
R=K·exp(−d) (5)

In the embodiment, information relating to the delay correlation coefficient R such as parameters (corresponding to K in the above Equation 5) necessary for calculating the delay correlation coefficient R, is set.

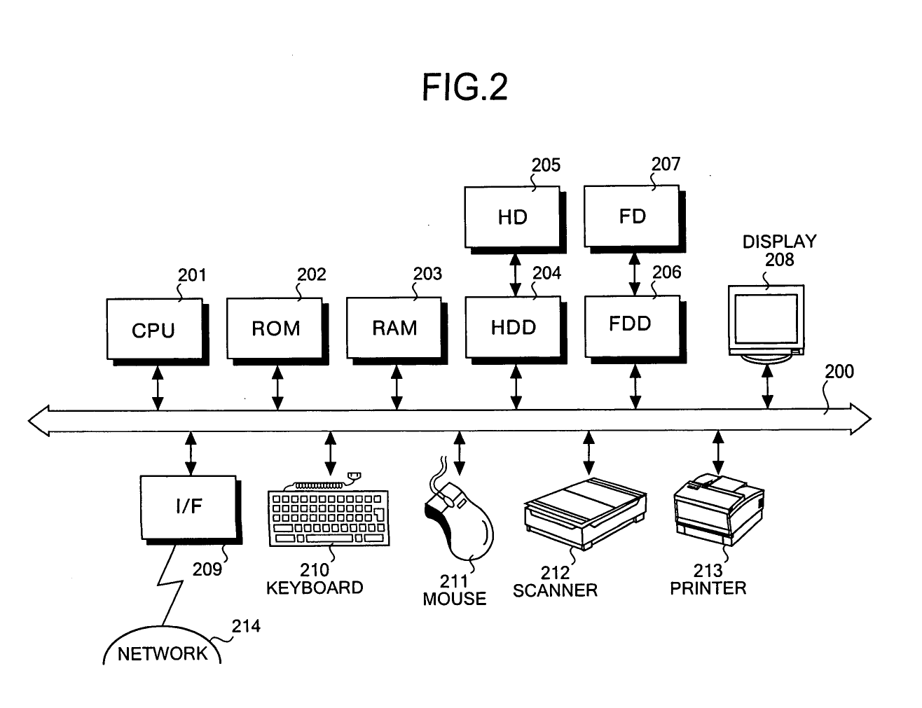

FIG. 2 is a schematic of a verification supporting apparatus according to the embodiment of the present invention. As shown in FIG. 2, the verification supporting apparatus includes a central processing unit (CPU) 201, a random-access memory (ROM) 202, a read-only memory (RAM) 203, a hard disk drive (HDD) 204, a hard disk (HD) 205, a flexible disk drive (FDD) 206, a flexible disk (FD) 207 as an example of a removable recording medium, a display 208, an interface (I/F) 209, a keyboard 210, a mouse 211, a scanner 212, and a printer 213. Each component is connected with others through a bus 200.

The CPU 201 controls the entire verification supporting apparatus. The ROM 202 stores programs such as a boot program. The RAM 203 is used as a work area of the CPU 201. The HDD 204 controls reading/writing of data from/to the HD 205 according to a control of the CPU 201. The HD 205 stores data written in the HD 205 according to a control of the HDD 204.

The FDD 206 controls reading/writing of data from/to the FD 207 according to a control of the CPU 201. The FD 207 stores data written in the FD 207 according to a control of the FDD 206 and causes the verification supporting apparatus to read the data stored in the FD 207.

Besides the FD 207, the removable recording medium may be a compact-disk read-only memory (CD-ROM), a compact-disk recordable (CD-R), a compact-disk rewritable (CD-RW), a magneto-optical (MO) disk, a digital versatile disk (DVD), and a memory card. The display 208 displays data such as texts, images, and functional information, in addition to a cursor, icons, and tool boxes. A cathode ray tube (CRT), a thin film transistor (TFT) liquid crystal display (LCD), and a plasma display may be employed as the display 208.

The I/F 209 is connected through a communication line with a network 214 such as the Internet, and is connected with another apparatus through the network 214. The I/F 209 administers the interface between the network 214 and the interior and controls input/output of data sent from an external apparatus. As the I/F 209, for example, a modem or an LAN adaptor may be employed.

The keyboard 210 includes keys for inputting letters, numerals, and various instructions, and is used for inputting data. Instead of the keyboard 210, a touch-panel-type input pad, and a numeric key pad may be used. The mouse 211 is used for moving the cursor, selecting an area, or moving or changing the size of a window. A track ball or a joy stick that also has the functions as a pointing device may be used.

The scanner 212 optically reads images and captures image data into the verification supporting apparatus. The scanner 212 may have an optical character reader (OCR) function. The printer 213 prints out image data and text data. As the printer 213, a laser printer or an ink-jet printer may be employed.

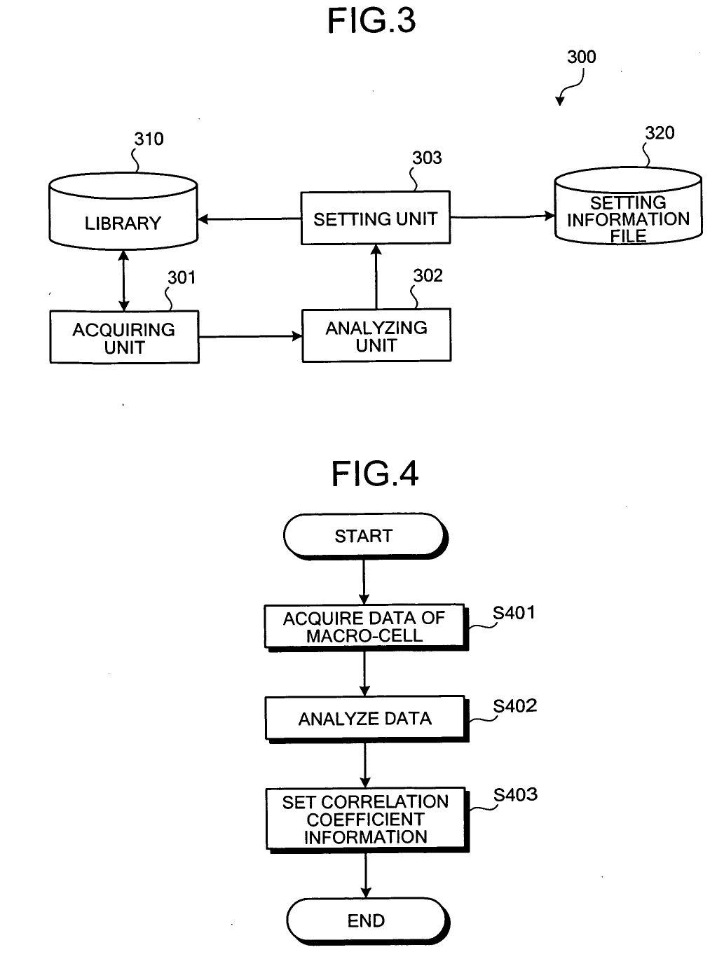

FIG. 3 is a block diagram of a verification supporting apparatus 300 according to the embodiment. As shown in FIG. 3, a verification supporting apparatus 300 includes a library 310, an acquiring unit 301, an analyzing unit 302, and a setting unit 303.

The library 310 stores library data relating to macro-cells. As a macro-cell, a logic gate such as an inverter, a buffer, an AND circuit, an OR circuit, an NAND circuit, and an NOA circuit, a sequential logic circuit such as a flip-flop (FF), a combinational logic circuit such as a coincidence circuit, a comparator, an encoder, a decoder, a multiplexer, and a demultiplexer can be listed. The library data include a layout shape having information relating to a position and a size of electrode patterns of a macro-cell, and various information relating to the macro-cell.

The acquiring unit 301 acquires the library data of an arbitrary macro-cell from the library 310. The library data may be extracted automatically from the library 310 or the library data designated by a user may be extracted.

The analyzing unit 302 analyzes the library data acquired by the acquiring unit 301. More specifically, the analyzing unit 302 analyzes, from the library data, a layout shape or characteristics of the macro-cell. From among results obtained from analysis, a result to be used by the setting unit 303 is designated. For example, the result to be used is designated by the user operation.

The setting unit 303 sets information relating to a delay correlation coefficient between the macro-cell and another macro-cell to be arranged adjacently to the macro-cell (hereinafter, “correlation coefficient information”) based on the result of the analysis. The correlation coefficient information includes identifying information relating to grouping of macro-cells and parameters that can be substituted directly in the equation for calculating the delay correlation coefficient R. The correlation coefficient information is used in calculating the correlation coefficients. The correlation coefficient information set by the setting unit 303 is stored in the library 310, or can be used by being written on a setting information file 320 outputting from the library 310.

More specifically, the acquiring unit 301, the analyzing unit 302, and the setting unit 303 realize the functions thereof by, for example, the CPU 201 executing a program recorded on a recording medium, such as the ROM 202, the RAM 203, and the HD 205, or by I/F 209.

FIG. 4 is a flowchart of a verification supporting process performed by the verification supporting apparatus 300. As shown in FIG. 4, by the acquiring unit 301, library data of a macro-cell is acquired from the library 310 (step S401).

By the analyzing unit 302, the acquired library data is analyzed (step S402). Based on a result of analysis designated by the designating unit, correlation coefficient information is set by the setting unit 303 (step S403).

Examples of the verification supporting apparatus 300 according will then be described. In the following examples, a first example to an eighth example are a case where the layout shape is designated from among results of the analysis, and a ninth example to a thirteenth example are a case where the characteristics of the circuit is designated.

In the first example, the correlation coefficient information is set based on gates of transistors constituting the macro-cell. The influence of an optical proximity effect correction is mainly considered in the first example. When a proximity pattern is used, because the width of the pattern is modulated due to the influence of the optical proximity effect (mainly diffraction caused by the edge of the pattern), the width is generally corrected on the original mask in advance. Because this correction is executed stepwise in response to the distance between patterns, the width varies stepwise in response to the distance even after the pattern is transferred on a silicon wafer.

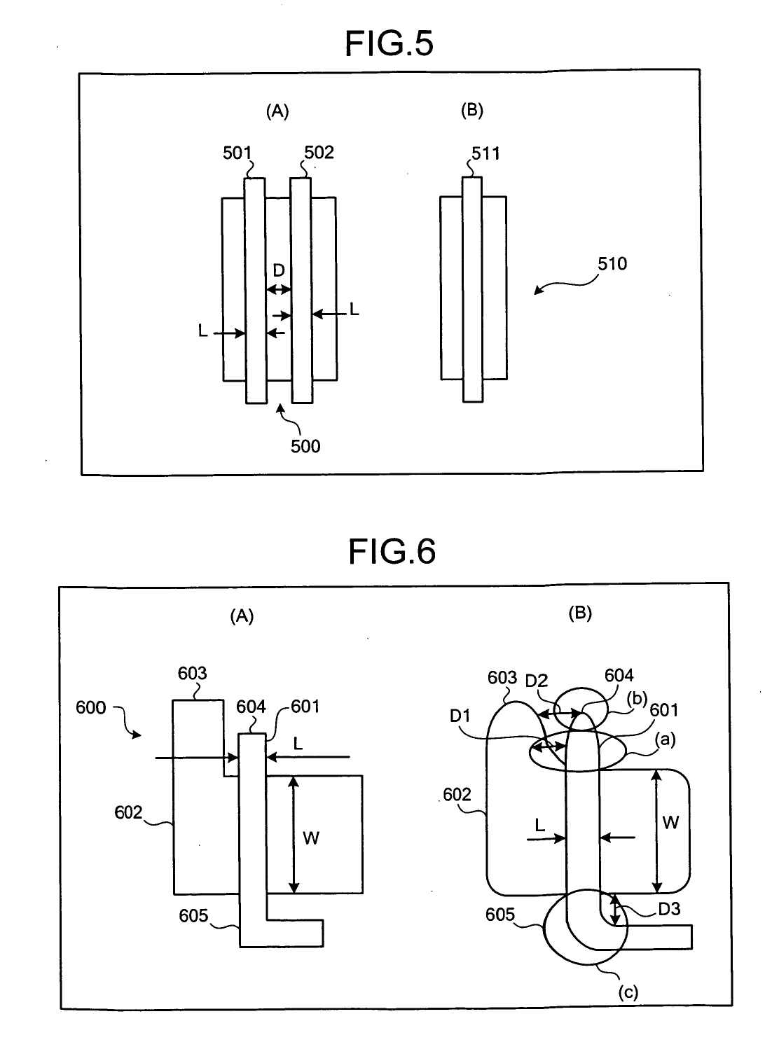

FIG. 5 is a schematic for illustrating layout shapes of transistors of the first example. A layout (proximity Poly) of a transistor 500 having two gates 501 and 502 that are in the proximity of each other and a layout (isolated Poly) of a transistor 510 having one gate 511 are shown.

In the gates 501 and 502, the gate length L is same as that of the isolated Poly of the transistor 510 on the layout, however, is different from that of the isolated Poly on an actual silicon wafer. When a distance D between the gates that is the spacing between the gate 501 and the gate 502 becomes larger to some degree, the proximity effect is lost and the proximity Poly becomes same as the isolated Poly. Because the correlation with another macro-cell arranged adjacent differs when the distance D between the gates differs, the correlation efficient varies. Therefore, correlation is grouped according to the distance between the gates 501 and 502.

For example, when it is found that a single gate is present in a layout of a transistor in a macro-cell from the result of the analysis, the layout of the transistor is set as an isolated Poly. In other words, the correlation coefficient information is set as identifying information for the isolated Poly. When the distance D between the gates is larger than a predetermined distance, the layout of the transistor is set as plural isolated Polys. In other words, the correlation coefficient information is set as identifying information for the isolated Poly.

When plural gates are present in a layout of a transistor within a macro-cell, and when the distance D between the gates is smaller than the predetermined distance, the layout of the transistor is set as the proximity Poly. In other words, the correlation coefficient information is set as the identifying information of the proximity Poly. In this case, a parameter corresponding to the distance D between the gates is set to provide an influence to the delay correlation coefficient R. By using this parameter, a delay correlation coefficient with another macro-cell can be accurately calculated.

In a second example, correlation coefficient information is set based on spacing between a gate and an active region of a transistor constituting a macro-cell. The correlation coefficient information is set according to an influence of the variation of a shape due to limitation on processing.

FIG. 6 is a schematic for illustrating layout shapes of transistors of the second example. A transistor 600 has an approximately L-shaped gate 601 and an active region 602.

In a processing, a corner portion of the pattern is generally rounded due to the limitation on the processing. Depending on the size of this round portion, the gate width or the gate length of the transistor is modulated. For example, in a portion (a) shown in FIG. 6, the gate width W of the transistor 600 is slightly widened being influenced by the rounding of the corner portion of the active region 602 because the L-shaped active region 602 and the gate 601 are in the proximity of each other. This amount of widening of the width is determined by the distance between the gate 601 and the active region 602, and the alignment precision for the pattern of the gate 601 and the active region 602.

A protruded portion 603 of the active region 602 is formed on the left of the gate 601. However, if the protruded portion is formed on the right or on both sides respectively, the degree of influence is different when the positions of the gate 601 and the active region 602 are shifted. Therefore, the gate width W of the transistor 600 varies in response to the distance D1 between the gate 601 and the active region 602, and the relation between the positions of the protruding portion 603 of the active region 602 and the gate 601.

In a portion (b), a tip 604 of the gate 601 is formed rounded. When a distance D2 from the active region 602 to the tip 604 of the gate 601 is short, the tip 604 reaches the active region 602 and the gate length L is slightly varied. In this case, influence is applied depending on the direction of the protruded portion 603 because the positioning of the active region 602 and the gate 601 also influences.

In a portion (c), a curved portion 605 of the gate 601 is formed rounded. Therefore, the curved portion 605 is influenced by a distance D3 between the gate 601 and the active region 602. In this case, the orientation of the curved portion 605 also influences.

In this way, L/W of the gate length L and the gate width W of the transistor 600 is varied by the positional relation and the distance between the two patterns (the gate 601 and the active region 602). This amount of variation is varied by the positioning in the fabrication process of the semiconductor circuit. Therefore, the delay value of this circuit using the transistor 600 occurs variation different from other variation. Therefore, the correlation of the delay is varied.

Therefore, the setting unit 303 can classify the transistor 600 using the following items as criteria.

The positional relation between the gate 601 and the active region 602.

The number of the protruded portions 603.

The distance D1 between the protruded portion 603 and the gate 601.

The distance D2 between the tip 604 and the active region 602.

The distance D3 between the curved portion 605 and the active region 602.

The setting unit 303 provides identifying information corresponding to the above criteria as correlation coefficient information. The provided correlation coefficient information is used in calculating the delay correlation coefficient R. By setting the correlation coefficient information with the distances D1 to D3 as the parameters, the information can be substituted in the equation for calculating the delay correlation coefficient R.

In a third example correlation coefficient information is set based on the number of a contact window and a position of the contact window of a transistor constituting a macro-cell.

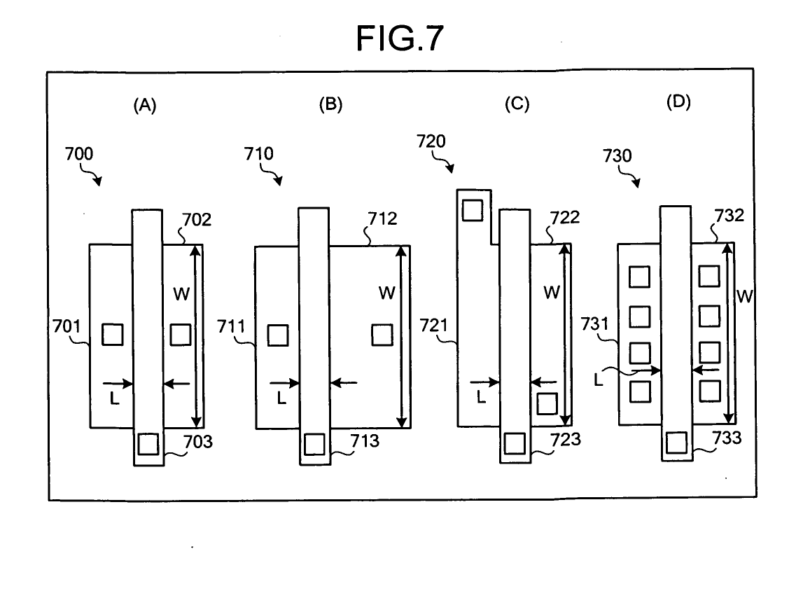

FIG. 7 is a schematic for illustrating layout shapes of transistors of the third example. In transistors 700, 710, 720, and 730, the ratios L/W of the gate length L and the gate width W of the transistors are all equal. For the transistors 700, 710, and 720, the number of contact windows (shown as squares in the drawing) is all equal (three). However, the number of contact windows for the transistor 730 is nine, which is different from that of the transistors 700, 710, and 720. For even the transistors 700, 710, and 720, the positions of the contact windows are different from that of other transistors.

Therefore, the setting unit 303 can classify the transistors 700, 710, 720, and 730 using the following items as criteria.

The number of contact windows.

The positions of the contact windows.

The setting unit 303 provides identifying information corresponding to the above criteria as the correlation coefficient information. The provided correlation coefficient information is used in calculating the delay correlation coefficient R. By setting the correlation coefficient information with the number of the contact windows as the parameters, the information can be substituted in the equation for calculating the delay correlation coefficient R.

In a fourth example, the correlation coefficient information is set based on shapes of source regions, drain regions, or gates of transistors constituting a macro-cell. The fourth example is explained referring to FIG. 7 used for explaining the third example.

For transistors 700, 710, 720, and 730, the ratio L/W of the gate length L and the gate width W is same. However, the magnitude of the resistances of source regions 701, 711, 721 and 731, drain regions 702, 712, 722 and 732, and gates 703, 713, 723 and 733 are all different.

In this case, influence from variation of the magnitude of the resistances of each of the source regions 701, 711, 721 and 731, the drain regions 702, 712, 722 and 732, and the gates 703, 713, 723 and 733 is different from that of each other. Therefore, the properties of each of the transistors 700, 710, 720, and 730 vary differently from each other.

Therefore, when the transistors having the source regions 701, 711, 721 and 731, the drain regions 702, 712, 722 and 732, and the gates 703, 713, 723 and 733 with respectively different resistance is used in a circuit, delay of each of the transistors varies differently from each other and the correlation of the delays also varies.

Therefore, the setting unit 303 can classify the transistors 700, 710, 720, and 730 using the following items as criteria.

The shape (width) of the source regions 701, 711, 721, and 731.

The shape (width) of the drain regions 702, 712, 722, and 732.

The shape (width) of the gates 703, 713, 723, and 733.

The setting unit 303 provides identifying information corresponding to the above criteria as correlation coefficient information. The provided correlation coefficient information is used in calculating the delay correlation coefficient R. By setting the correlation coefficient information with the shape (width) in the above criteria as the parameters, the information can be substituted in the equation for calculating the delay correlation coefficient R.

In a fifth example, the correlation coefficient information is set based on shapes of source regions, drain regions or gates of transistors constituting a macro-cell.

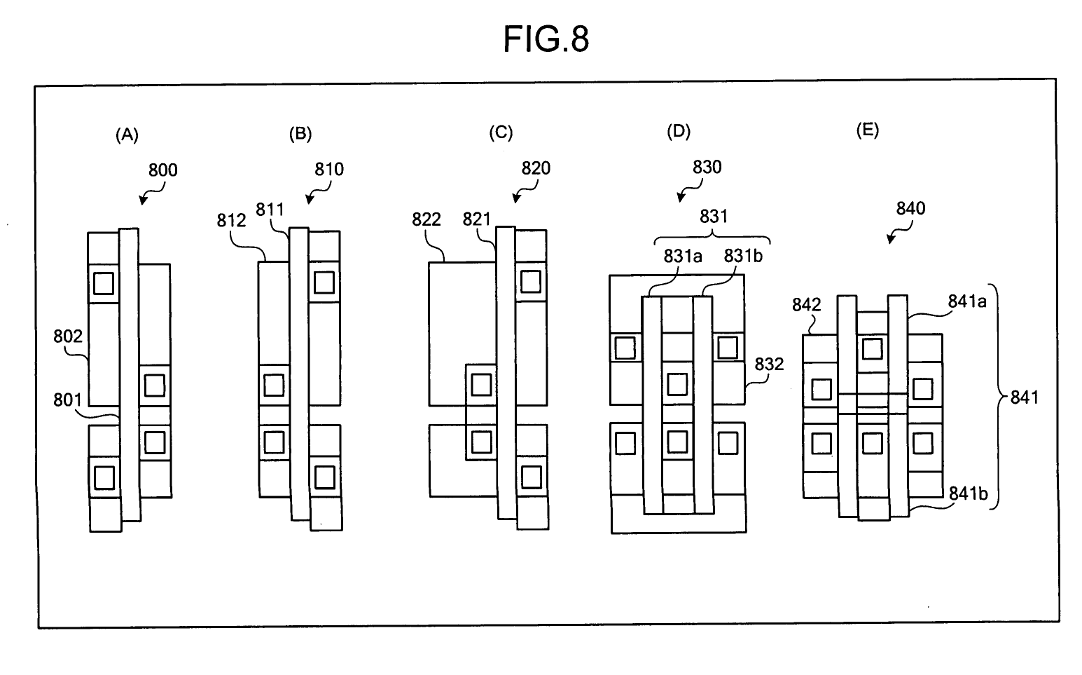

FIG. 8 is a schematic for illustrating layout shapes of inverters according to the fifth example. Inverters 800, 810, 820, 830, and 840 are the same circuits. When a gate 801 is shifted to the right relatively to an active region 802, the area of a drain is reduced. When a gate 811 is shifted to the right relatively to an active region 812, the area of a drain is increased.

When a gate 821 is shifted to the right relatively to an active region 822, the area of a drain is increased because the positions of a source region and the drain region of an active region 822 are varied. However, the rate of the increase is different from that of the inverter 810.

When a gate 831 (831a and 831b) is shifted to the right relatively to an active region 832, the area of a drain is constant without any increase and decrease. Similarly, when a gate 841 (841a and 841b) is shifted to the right relatively to an active region 842, the area of a drain is constant without any increase and decrease.

As described above, the areas of the drains and parasitic capacities are varied by the shift of the positions between the gates 801, 811, 821, 831, and 841, and the active regions 802, 812, 822, 832, and 842. Therefore, the delay value of a circuit using these inverters 800, 810, 820, 830, and 840 shows different variations respectively for the shift of the gates 801, 811, 821, 831, and 841.

Therefore, the setting unit 303 can classify the transistors 800, 810, 820, 830, and 840 using the following items as criteria.

Shapes (the areas) of the source regions in the active regions 802, 812, 822, 832, and 842.

Shapes (the areas) of the drain regions in the active regions 802, 812, 822, 832, and 842.

The setting unit 303 provides identifying information corresponding to the above criteria as correlation coefficient information. The provided correlation coefficient information is used in calculating the delay correlation coefficient R. By setting the correlation coefficient information with the shapes (the areas) of the source regions or the drain regions that satisfy the above criteria as the parameters, the information can be substituted in the equation for calculating the delay correlation coefficient R.

In a sixth example, the correlation coefficient information based on the gate length or the gate width of a transistor constituting a macro-cell. More specifically, the correlation coefficient information is set when the delay is varied by the gate length L and the gate width W.

In general, a variation amount ΔL is constant regardless of the gate length L. Because of the roll-off property of a transistor, a variation amount becomes smaller as the gate length L becomes larger even when the same amount ΔL is varied. For smaller L/W, the variation is more susceptible to the influence of the fluctuation of the impurity concentration in the channel portion of a transistor. That is, the correlation is easier to be apparent as the L/W becomes larger and is more difficult as the L/W becomes smaller.

Therefore, by setting the correlation coefficient information with the L/W of the transistors as parameters, the setting unit 303 can substitute those parameters in the equation for calculating the delay correlation coefficient R.

In a seventh example the correlation coefficient information is set based on a shape of a channel portion of a transistor constituting a macro-cell.

When a shallow trench isolation (STI) process is applied, a stress is generated in an active region depending on the material filled in a trench portion due to the difference in thermal expansion coefficient between the material and silicon. This stress causes modulation of the carrier mobility and the transistor properties are varied.

When the active region is large, the stress is dispersed and becomes small if the channel portion of the transistor is far from the edge of the active region. The channel portion of the transistor is susceptible to a large stress if the channel portion is close to the edge of the active region.

The recent wafer process technology may vary the transistor properties using the stress actively by adding a process step that adds a material that generates a stress. In this case, selection of the portions to be added with stresses is possible by adding a mask layer. The variation of the transistor properties cause the delay value to vary.

That is, delay values of circuits using transistors that are applied with stresses approximately in the same way easily show the correlation between the circuits, and delay values of circuits using transistors that are applied with stresses respectively in a different way from each other is difficult to show the correlation between the circuits.

Therefore, the setting unit 303 can classify transistors using the following items as criteria.

The area of an active region.

The position of a gate.

The setting unit 303 provides identifying information corresponding to the above criteria as correlation coefficient information. The provided correlation coefficient information is used in calculating the delay correlation coefficient R. By setting the correlation coefficient information with the stress applied on the channel portion as the parameters, the information can be substituted in the equation for calculating the delay correlation coefficient R.

In an eighth example, the correlation coefficient information is set based on spacing between active regions in a circuit constituting a macro-cell.

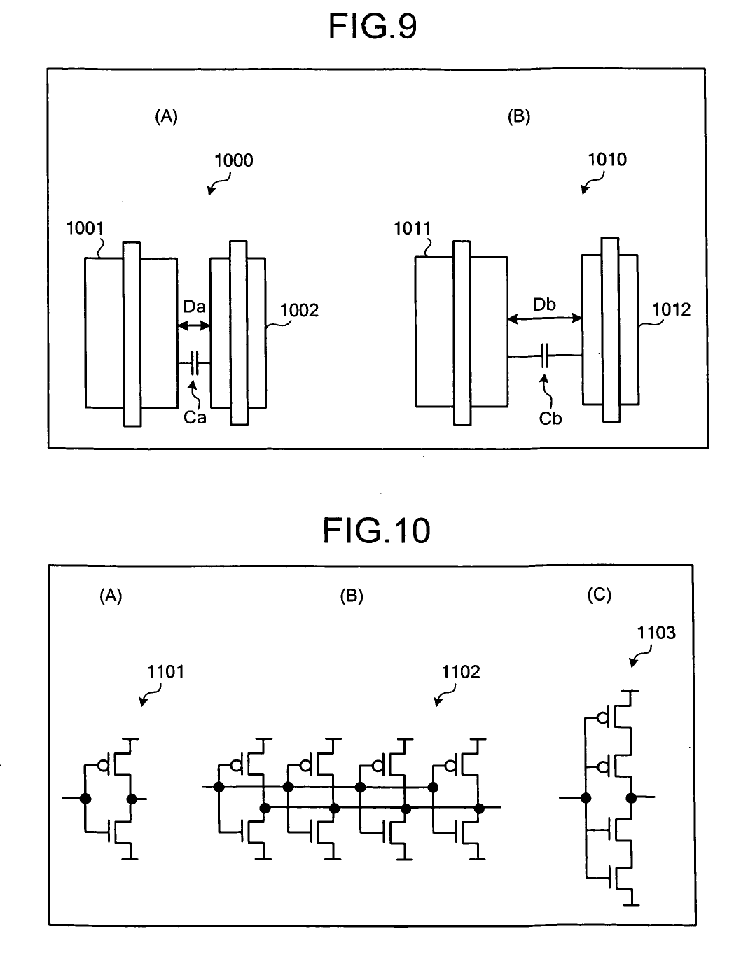

FIG. 9 is a schematic for illustrating layout shapes of a circuit of the eighth example. A circuit 1000 and a circuit 1010 respectively include the same transistors. However, an active spacing Da between active regions 1001 and 1002 of the circuit 1000 and an active spacing Db between active regions 1011 and 1012 of the circuit 1010 are different.

Because the active spacing Da and Db are different, parasitic capacity values Ca and Cb are different, and influence delay values. Therefore, the way the delay correlation appears is different between the circuits shown in FIGS. 10A and 10B. When an STI process is used, a force applied by an insulating material located between the active regions is different due to the difference between the active spacing Da and Db. Therefore, the transistor properties varies following the variation of the internal stresses, and the delay values also vary due to the influence caused by the variation of the transistor properties.

As described above, even when the L/Ws of internal transistors are the same, the delay value of a circuit is caused different variation. Therefore, by setting the correlation coefficient information with the active spacing Da and Db as the parameters, the setting unit 303 can substitute the information in the equation for calculating the delay correlation coefficient R.

In a ninth example, the correlation coefficient information is set based on a type of a circuit constituting a macro-cell. More specifically, the correlation coefficient information is set when a process that varies the transistor properties is added and transistors of plural types that respectively have different properties or special elements (resistance elements or capacity elements) are used.

For example, transistors that respectively have different properties may be fabricated on a single chip by adding impurity diffusion processes for channel portions, and processes that change the thickness of oxide films to realize various circuit properties. Because each of these processes is independent for each type of transistor, for example, a case is present where a transistor in a group A has a first impurity diffusion process but a second impurity diffusion process, and a group B does not have the first impurity diffusion process but the second impurity diffusion process.

In this case, the transistor in the group A is influenced by the fluctuation caused by the first impurity diffusion process but the fluctuation caused by the second impurity diffusion process and the transistor in the group B is not influenced by the fluctuation caused by the first impurity diffusion process but the fluctuation caused by the second impurity diffusion process. Therefore, the correlation between the group A and the group B is weaker than each correlation between the transistor properties in the group A and each correlation between the transistor properties in the group B. The above is true when a process is added to either of the group A or the group B.

As described above, the correlation of the delays of the circuit using these transistors also depends on the correlation of the transistor properties described above. Similarly, because some circuits use capacity elements, resistance elements, and capacity elements, the delay property may be influenced by these elements.

Therefore, the setting unit 303 can classify the transistors using the following items as criteria and provides identifying information corresponding to the following criteria as the correlation coefficient information. The provided correlation coefficient information is used in calculating the delay correlation coefficient R.

The group relating to the transistor properties classified according to the type of a fabricating process.

The group relating to the properties of resistance elements and capacity elements contained in the circuit used in the transistor.

### TENTH EXAMPLE

In a tenth example, correlation coefficient information is set based on the number of connected transistors and a connection type of transistors constituting a macro-cell.

FIG. 10 is a schematic of transistors according to the tenth example. Circuits shown in FIG. 10 are all inverter circuits. However, the inverter circuit 1101 uses respectively one P-channel transistor and one N-channel transistor. Therefore, the variation of the transistor properties of one transistor directly becomes the delay variation.

In the inverter circuit 1102, four P-channel transistors and four N-channel transistors are respectively connected in series. Therefore, the delay variation of the inverter circuit 1102 becomes the average of the transistor property variation of the four transistors.

Similarly, in the inverter circuit 1103, two P-channel transistors and two N-channel transistors are connected in parallel. Therefore, the delay variation of the inverter circuit 1103 becomes the average of the transistor property variation of each transistor.

That is, in the inverter circuit 1101, the amount of variation of the transistor properties of one transistor directly becomes the amount of variation of the delay, whereas, in inverter circuits 1102 and 1103, the average of the amount of variation of the transistor properties in series/parallel becomes the amount of variation of the delay. Therefore, the correlation in the delay between the inverter circuits 1102 and 1103 is stronger than the correlation in the delay with the inverter circuit 1101.

The setting unit 303 can classify the transistors using the number of connected transistors and the type of connection (in series or in parallel) as criteria. By setting the correlation coefficient information with the number of connected transistors as a parameter, the information can be substituted in the equation for calculating the delay correlation coefficient R.

In an eleventh example, correlation coefficient information is set based on presence or absence of a transmission gate in a transistor constituting a macro-cell.

FIG. 11 is a schematic of transistors according to the eleventh example. A circuit 1200 using a normal gate 1201 and a circuit 1210 using a transmission gate 1211 are shown.

In the gate 1201 of the circuit 1200, rise/fall are respectively determined by either one of a P-channel transistor or an N-channel transistor. In the transmission gate 1211 of the circuit 1210 shown in FIG. 11, for both of rise/fall, the transistor properties of a P-channel transistor and an N-channel transistor constituting the transmission gate 1211 influences the delays.

The correlation between the transistor properties of each of the P-channel transistor and the N-channel transistor is weaker than the correlation between transistors having the same type of channel. Therefore, the correlation between the delays in the circuit 1210 that uses the transmission gate 1211 is weaker than the correlation between the delays in the circuit 1200 that does not use the transmission gate 1211.

The setting unit 303 provides identifying information relating to the use or non-use of the transmission gate 1211 as correlation coefficient information. The provided correlation coefficient information is used in calculating the delay correlation coefficient R.

In a twelfth example, correlation coefficient information is set based on an orientation of a transistor constituting a macro-cell. More specifically, the correlation coefficient information is set when the delay value is varied by the orientation (longitudinal/lateral) of a transistor. The shape of a transistor differs depending on whether the transistor is longitudinal/lateral due to the dependence of an exposure apparatus on orientation and errors and the tendency of an etching apparatus. When the shape differs, the delay value also differs in response to the longitudinal/lateral pattern.

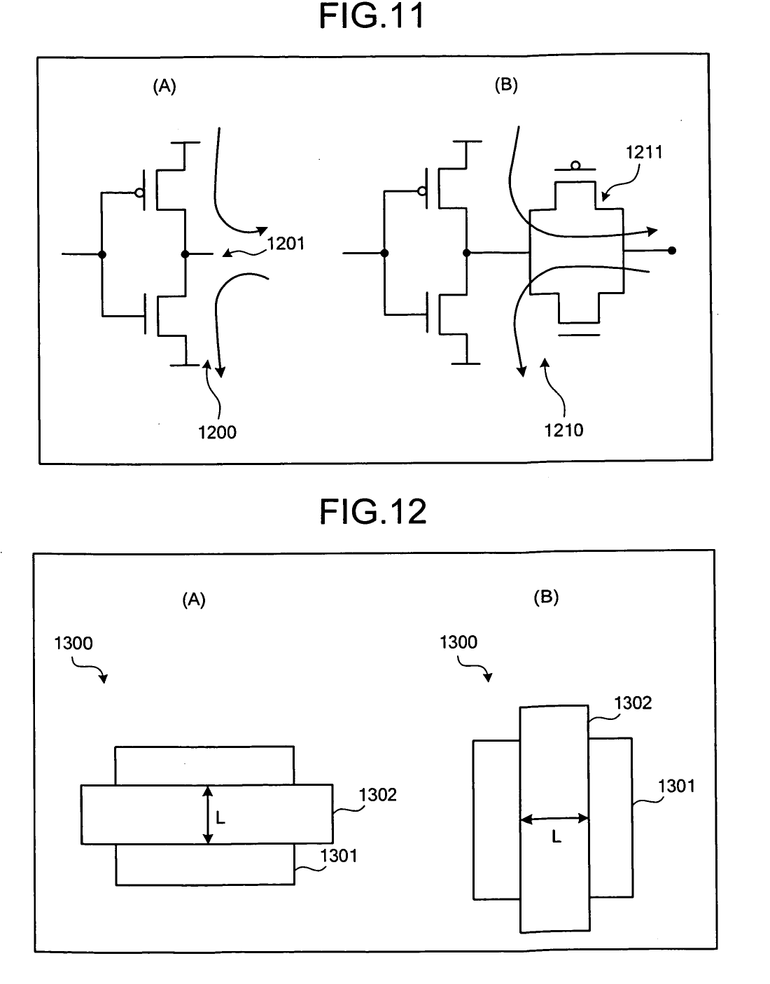

FIG. 12 is a schematic for illustrating layout shapes of transistors according to the twelfth example. A transistor 1300 arranged laterally and the transistor 1300 arranged longitudinally are shown.

For example, when a gate 1302 is shifted upward or downward relatively to an active region 1301 in a figure (A) shown in FIG. 12, the area of a source/drain is varied. However, the area is not varied in a figure (B) shown in FIG. 12. When the gate 1302 is shifted to the right or left, the area of the source/drain is varied in the figure (B). In the figure (A), the gate length is slightly varied when a protrusion of the gate 1302 is short. Therefore, the way the correlation between the delays appears is varied by the orientation of the transistor 1300.

Therefore, the setting unit 303 provides the orientation (longitudinal/lateral) of arrangement of the transistor 1300 as correlation coefficient information. By setting the correlation coefficient information with the area of the source/drain and the gate length L that are varied by the orientation of arrangement as the parameters, the information can be substituted in the equation for calculating the delay correlation coefficient R.

In a thirteenth example, the correlation coefficient information is set based on a wiring in a macro-cell. When the wiring occupation and the bulk occupation in a macro-cell are compared to each other, the delay is influenced because the resistance value and parasitic capacity generated to the wiring differ due to the percentage of those occupancies. More specifically, a macro-cell having a low occupancy is less likely to be influenced by the dispersion caused by the wiring process, and a macro-cell having a high occupancy is likely to be influenced by the dispersion.

Therefore, the setting unit 303 provides the percentages of the occupancies in the macro-cell as correlation coefficient information. By setting the correlation coefficient information with the percentages of the occupancies in the macro-cell as the parameters, the information can be substituted in the equation for calculating the delay correlation coefficient R.

Depending on a routing of wires in a macro-cell, the delay value is varied because the resistance value of the wiring and the capacity values between wires differ. Therefore, the portion of the delay contributed by the wiring in the delay of the macro-cell is estimated, and by setting correlation coefficient information with the estimated value as a parameter, the information can be substituted in the equation for calculating the delay correlation coefficient R.

A fourteenth example, correlation coefficient information is set based on presence or absence of butting contacts in a macro-cell. A butting contact is a back-gate electrode of a metal oxide semiconductor (MOS) transistor, formed by using the same type of diffusion species (P-type/N-type) as that of a back-gate for a portion of a source diffusion region without forming a dedicated diffusion region for the back-gate.

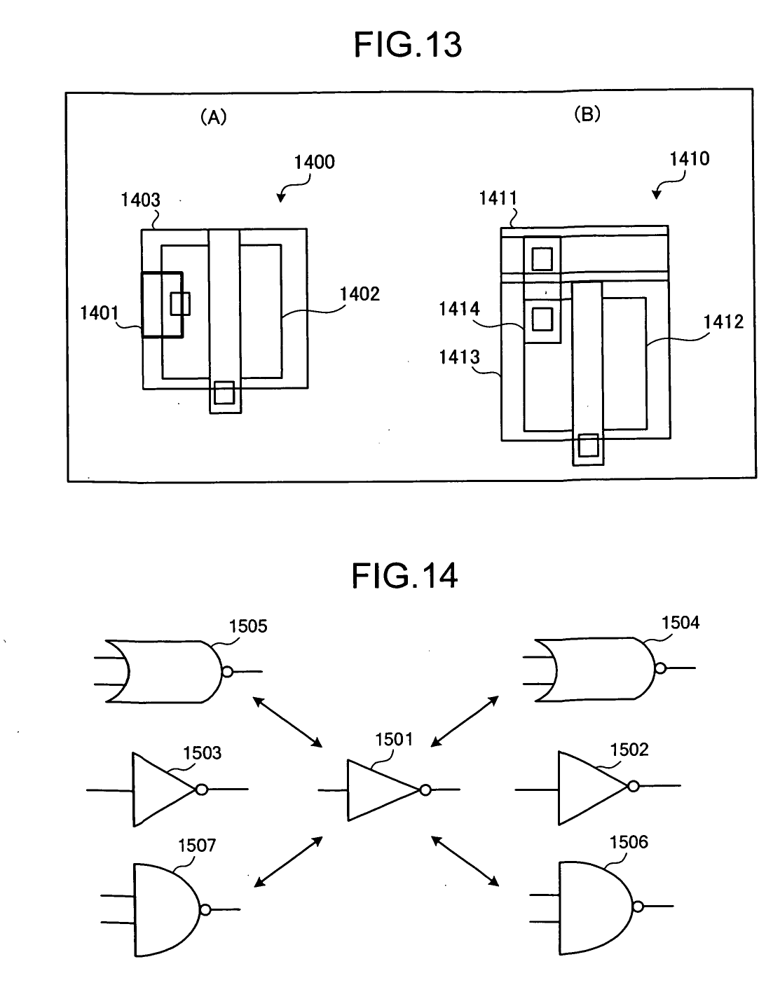

FIG. 13 is a schematic for illustrating layout shapes of transistors according to the fourteenth example. In a transistor 1400, a P-type diffusion region (Well-Tap) 1401 indicated by a thick-line frame is a butting contact. During an ion implantation process, when the P-type diffusion region 1401 has infiltrated to an active region 1402 due to an error in alignment, an N-type diffusion region 1403 implanted into on the side of the transistor 1400 is varied and vice versa. Therefore, the amount of variation of the parasitic capacity value of the active region 1402 differs and the transistor properties are influenced by the difference. The delay value is also varied.

In a transistor 1410, a P-type diffusion region 1411 and an N-type diffusion region 1413 having an active region 1412 are connected by a metal wire 1414. However, connecting to the P-type diffusion region 1411 by the metal wire 1414 is less likely to be influenced by the variation of the parasitic capacity value of the active region 1412. In this way, the way the correlation between the delays appears differs due to the presence or absence of the butting contact.

Therefore, the setting unit 303 provides the presence or absence of the butting contact as correlation coefficient information. The provided correlation coefficient information is used in calculating the delay correlation coefficient R. By setting the correlation coefficient information with the amount of variation of the parasitic capacity value of the active region 1402 as the parameters, the information can be substituted in the equation for calculating the delay correlation coefficient R.

In a fifteenth example, correlation coefficient information is set based on a type of a macro-cell and a types of other macro-cells. Because the library 310 can identify the type of a macro-cell by the cell name of the macro-cell, the correlation coefficient is set using a combination of these identified types.

FIG. 14 is a schematic of macro-cells according to the fifteenth example. Focusing on a macro-cell 1501 representing an inverter, when another macro-cell arranged adjacent to the macro-cell 1501 is a macro-cell 1502 or a macro-cell 1503, the correlation is strong because the macro-cells 1501 to 1503 are inverters.

When the other macro-cells arranged adjacent to the macro-cell 1501 are macro-cells 1504 to 1507, the correlation is weak because the macro-cells are NOR circuits or NAND circuits. In this way, the way the correlation appears differs depending on the type of the macro-cells, the setting unit 303 sets a parameter corresponding to the combination of the types of both of the macro-cells that are arranged adjacently to each other, as the correlation coefficient information. Thereby, the parameter can be substituted in the equation for calculating the delay correlation coefficient R.

As described above, the correlation between a macro-cell and other macro-cells arranged adjacent to the macro-cell can be set in response to the layout and the characteristics of the macro-cell. Therefore, the timing verification relating to a semiconductor circuit can be executed easily and with a high precision.

The verification supporting method described referring to the embodiments can be realized by executing a computer program prepared in advance on a computer such as a personal computer and a work station. This program is recorded on a computer-readable recording medium, such as a hard disk, a flexible disk, a CD-ROM, an MO, and a DVD, and is executed by being read from the recording medium by a computer. This program may be in a form of a transmissible medium that can be distributed through a network such as the Internet.

According to the embodiments described above, timing verification of a semiconductor circuit can be executed easily and with high precision.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A verification supporting apparatus comprising:
a storage unit configured to store data on at least one macro-cell;
an acquiring unit configured to acquire data on a macro-cell from the storage unit;
an analyzing unit configured to analyze acquired data; and
a setting unit configured to set information relating to a correlation coefficient of the macro-cell with respect to an adjacent macro-cell that is arranged adjacent to the macro-cell, based on a result of analysis by the analyzing unit.

2. The verification supporting apparatus according to claim 1, wherein the analyzing unit is configured to analyze a layout shape of the macro-cell.

3. The verification supporting apparatus according to claim 1, wherein the setting unit is configured to set the information based on number of gate of a transistor constituting the macro-cell.

4. The verification supporting apparatus according to claim 3, wherein the setting unit is configured to set, when the number of gate is more than one, the information based on spacing between gates.

5. The verification supporting apparatus according to claim 1, wherein the setting unit is configured to set the information based on spacing between a gate and an active region of a transistor constituting the macro-cell.

6. The verification supporting apparatus according to claim 1, wherein the setting unit is configured to set the information based on a contact window of a transistor constituting the macro-cell.

7. The verification supporting apparatus according to claim 1, wherein the setting unit is configured to set the information based on a shape of any one of a source region, a drain region, and a gate region of a transistor constituting the macro-cell.

8. The verification supporting apparatus according to claim 1, wherein the setting unit is configured to set the information based on any one of a gate length and a gate width of a transistor constituting a macro-cell.

9. The verification supporting apparatus according to claim 1, wherein the setting unit is configured to set the information based on a shape of a channel portion of a transistor constituting the macro-cell.

10. The verification supporting apparatus according to claim 1, wherein the setting unit is configured to set the information based on spacing between active regions in a circuit constituting the macro-cell.

11. The verification supporting apparatus according to claim 1, wherein the analyzing unit is configured to analyze a characteristic of a circuit constituting the macro-cell.

12. The verification supporting apparatus according to claim 11, wherein
the characteristic includes a type of the circuit, and
the setting unit is configured to set the information based on the type.

13. The verification supporting apparatus according to claim 11, wherein
the characteristic includes number of connected transistor constituting the macro-cell, and
the setting unit is configured to set the information based on the number.

14. The verification supporting apparatus according to claim 11, wherein
the characteristic includes presence or absence of a transmission gate in a transistor constituting the macro-cell, and
the setting unit is configured to set the information based on the presence or absence of the transmission gate.

15. The verification supporting apparatus according to claim 11, wherein
the characteristic includes orientation of a transistor constituting the macro-cell, and
the setting unit is configured to set the information based on the orientation.

16. The verification supporting apparatus according to claim 11, wherein
the characteristic includes a condition of wiring in the macro-cell, and
the setting unit is configured to set the information based on the condition of wiring.

17. The verification supporting apparatus according to claim 11, wherein
the characteristic includes presence or absence of a butting contact in the macro-cell, and
the setting unit is configured to set the information based on the presence or absence of the butting contact.

18. The verification supporting apparatus according to claim 11, wherein
the characteristic includes a type of the macro-cell and a type of the adjacent macro-cell, and
the setting unit is configured to set the information based on the types.

19. A verification supporting method comprising:
storing data on at least one macro-cell;
acquiring data on a macro-cell from among stored data;
analyzing acquired data; and
setting information relating to a correlation coefficient of the macro-cell with respect to an adjacent macro-cell that is arranged adjacent to the macro-cell, based on a result of analysis at the analyzing.

20. A computer-readable recording medium that stores therein a computer program for realizing a verification supporting method, the computer program making a computer execute:
storing data on at least one macro-cell;
acquiring data on a macro-cell from among stored data;
analyzing acquired data; and
setting information relating to a correlation coefficient of the macro-cell with respect to an adjacent macro-cell that is arranged adjacent to the macro-cell, based on a result of analysis at the analyzing.
